(19) United States
(12) Patent Application Publication
(10) Pub. No.: US 2026/0089614 A1
(43) Pub. Date: Mar. 26, 2026

(54) Concurrent Ranging Using Narrowband-Aided Multi-Millisecond

(71) Applicant: Apple Inc., Cupertino, CA (US)

(72) Inventors: Qiang CHEN, Fremont, CA (US); Sandeep V. KHARE, Cupertino, CA (US); Akbar GHASEMI, San Jose, CA (US); Adwait N. DONGARE, Palo Alto, CA (US); Richard B. ONG, San Francisco, CA (US); Robert GOLSHAN, San Jose, CA (US)

(21) Appl. No.: 19/341,156

(22) Filed: Sep. 26, 2025

Related U.S. Application Data
(60) Provisional application No. 63/699,286, filed on Sep. 26, 2024.

(51) Int. Cl. H04W 48/16; H04L 5/00; H04W 48/10

(52) U.S. Cl. CPC H04W 48/16; H04L 5/0048; H04W 48/10

(57) ABSTRACT

An apparatus configured to perform one or more of an advertising operation, a scanning operation, and a Narrowband-aided multi-millisecond (NBA-MMS) ranging operation for a first wireless device in a first timing interval and perform one or more of an advertising operation, a scanning operation, and an NBA-MMS ranging operation for a second wireless device in the first timing interval or a successive timing interval.

### BACKGROUND

Narrowband-aided multi-millisecond (NBA-MMS) has been proposed as a ranging technique (also referred to as narrow-band assisted (NBA)-multi-millisecond (MMS)-UWB ranging). Narrowband (NB) radio aids Ultra-wideband (UWB) by improving its link budget and extending its operational range. Ranging may be either Peer-to-Peer (P2P) involving two devices, or Multi-Peer (MP) involving multiple devices. Prior to ranging, devices time synchronize with each other by performing NB acquisition. In general, an Initiator broadcasts NB Acquisition Poll (NAPs) packets. A Responder scans for NAPs and upon reception transmits a NB Acquisition Response (NAR) packet. Acquisition is completed when the Initiator sends a final Start of Ranging (SOR) packet.

Further techniques for improving ranging using NBA-MMS and for performing NB acquisition are desirable.

### SUMMARY

Some example embodiments are related to an apparatus having processing circuitry coupled to memory, the processing circuitry configured to perform one or more of an advertising operation, a scanning operation, and a Narrowband-aided multi-millisecond (NBA-MMS) ranging operation for a first wireless device in a first timing interval and perform one or more of an advertising operation, a scanning operation, and an NBA-MMS ranging operation for a second wireless device in the first timing interval or a successive timing interval.

Other example embodiments are related to an apparatus having processing circuitry coupled to memory, the processing circuitry configured to perform a first Narrowband-aided multi-millisecond (NBA-MMS) ranging operation for a first wireless device in a first ranging interval, perform a second NBA-MMS ranging operation for the first wireless device in a second ranging interval successive to the first ranging interval and perform at least one of the following randomly select an ultra-wideband (UWB) preamble for one or more of the first ranging interval and the second ranging interval, the UWB preamble being randomly selected from a set of N preamble sequences, wherein N is a positive integer or add a dither delay period to each of the first and second ranging intervals, where the amount of the dither delay period is randomly selected for each of the first and second ranging intervals.

### BRIEF DESCRIPTION OF THE DRAWINGS

FIG. 1 shows an example network arrangement according to various example embodiments.

FIG. 2 shows an example wireless device according to various example embodiments.

FIG. 3A shows an example of a triangle finding scenario between multiple wireless devices according to various example embodiments.

FIG. 3B shows an example of a two device-to-one-device finding scenario between multiple wireless devices according to various example embodiments.

FIG. 4 shows an example multi-peer scheduling technique for multi-peer finding according to various embodiments.

FIG. 5 shows an example NBA-MMS protocol for one ranging cycle according to various example embodiments.

### DETAILED DESCRIPTION

The example embodiments may be further understood with reference to the following description and the related appended drawings, wherein like elements are provided with the same reference numerals. The example embodiments relate to improved techniques for concurrent ranging for wireless devices using NBA-MMS and for performing NB acquisition. In particular, multi-peer finding scenarios and techniques are proposed, whereby effective multi-peer scheduling for multi-peer finding is disclosed for wireless devices to concurrently find, and perform ranging with, multiple other wireless devices at the same time. Further, improved techniques for NBA-MMS ranging in congested settings are proposed.

The example embodiments are described with respect to devices that may operate according to the IEEE 802.15.4ab standard. However, the example embodiments of the ranging operation may be used by devices using any UWB protocol. In addition, the terms wireless personal area network (WPAN) and Ultra-Wideband (UWB) network are used interchangeably throughout this description and those skilled in the art will understand the general characteristics of such networks.

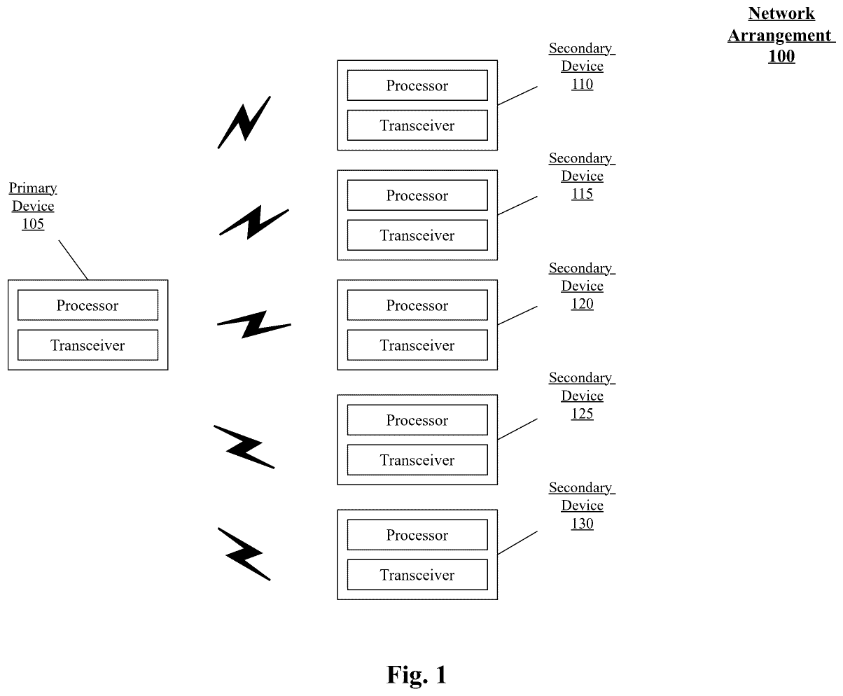

FIG. 1 shows an example network arrangement 100 according to various example embodiments. The example network arrangement 100 includes a primary device 105 and a plurality of secondary devices 110-130. The primary device 105 and the secondary devices 110-130 may be any type of electronic component that is configured to operate within a UWB network or over one or more UWB connections, e.g., mobile phones, tablet computers, smartphones, phablets, embedded devices, wearable devices, Cat-M devices, Cat-M1 devices, MTC devices, eMTC devices, other types of Internet of Things (IoT) devices, access points, etc. An actual network arrangement may include any number of secondary devices. The example of five secondary devices 110-130 is only provided for illustrative purposes. Any of the devices 105-130 may be designated a primary device and similarly, any of the devices 105-130 may be designated as a secondary device for a particular ranging operation. In the example embodiments, the device that initiates the ranging operation may be designated as the primary device.

The primary device 105 and the secondary devices 110-130 may be configured to communicate over one or more UWB connections. However, the primary device 105 and the secondary devices 110-130 may also communicate using other types of wireless connections and/or networks (cellular or non-cellular), and may also communicate using a wired connection. With regard to the example embodiments, the primary device 105 and the secondary devices 110-130 may communicate over UWB to, among other functionalities, transmit and/or receive data.

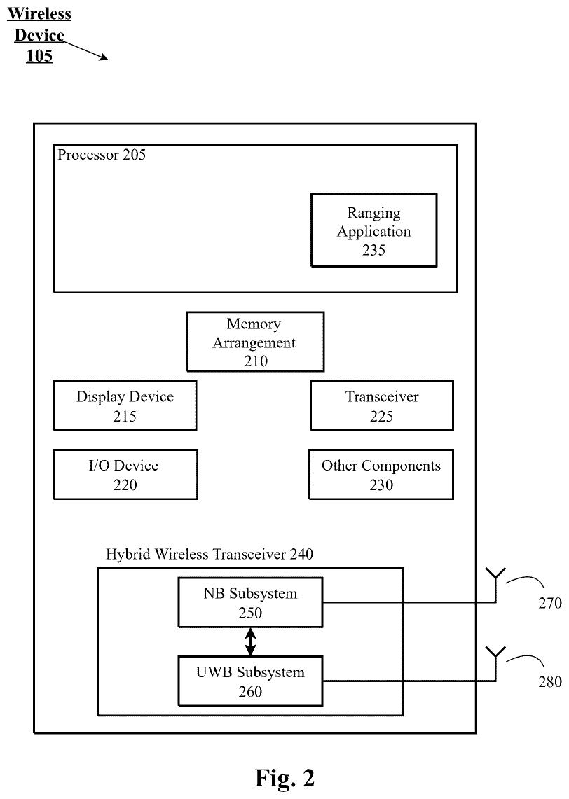

FIG. 2 shows an example wireless device 105 according to various example embodiments. The example wireless device 105 of FIG. 2 may also represent any of the other wireless device 110-130 of the network arrangement 100. The wireless device 105 may include a processor 205, a memory arrangement 210, a display device 215, an input/out (I/O) 220, a transceiver 225, and other components 230. The other components 230 may include, for example, an antenna, an audio input device, an audio output device, a battery, a data acquisition device, ports to electrically connect to other electronic devices, etc.

The processor 205 may be configured to execute a plurality of applications of the device 105. In some example embodiments, an application may include a ranging application 235 as will be described in greater detail below. The described functionalities of the wireless device 105 being represented as an application (e.g., a program) executed by the processor 205 is only an example. The functionality associated with the applications may also be implemented as a separate incorporated component of the wireless device 105 or may be a modular component coupled to the wireless device 105, e.g., an integrated circuit with or without firmware. In addition, in some wireless devices, the functionality described for the processor 205 is split among two processors, e.g., a baseband processor and an application processor. The example embodiments may be implemented in any of these or other configurations of a wireless device.

The transceiver 225 may be a hardware component configured to transmit and/or receive signals. For example, the transceiver 225 may enable communication with other electronic devices directly or indirectly through one or more networks based upon a protocol and an operating frequency of the network. The transceiver 225 may operate on a variety of different frequencies or channels (e.g., set of consecutive frequencies). Thus, one or more antennas (not shown) coupled with the transceiver 225 may enable the transceiver 225 to communicate with one or more other wireless devices (e.g., wireless devices 110-130) via UWB.

The example embodiments describe the primary device 105 determining a distance to and/or a location of each of the plurality of secondary devices 110-130 using a ranging operation. Throughout this description, the term “distance” will be used to refer to the distance between devices and/or the location of the secondary device 110-130 either relative to the primary device 105 or an absolute location within a particular space. Three example ranging modes are described. A single node ranging mode may be utilized for determining a distance to a single secondary device, e.g., secondary device 110. A multicast ranging mode may be utilized for determining a distance to a plurality of secondary devices, e.g., secondary devices 110-130, when the number and identity of the secondary devices 110-130 are known to the primary device 105. For example, in the network arrangement 100, the number of secondary devices is five. The identity of the secondary devices 110-130 may be known to the primary device 105 through any number of manners, e.g., previous data exchanges, previous ranging operations, etc. A broadcast ranging mode may be utilized for determining a distance to a plurality of secondary devices, e.g., secondary devices 110-130, when the number of secondary devices and the identity of each of the secondary devices are not known to the primary device 105. However, even when the identities of the secondary devices 110-130 are not known to the primary device 105, the devices 105-130 may share a common key that may be used to receive station-to-station messages. For example, keys may be shared via an upper layer protocol either over UWB or a sideband channel.

The ranging application 235 may implement one or more of these ranging modes.

The wireless device 105 may also be configured to communicate with one or more other similarly configured wireless devices by utilizing a hybrid of UWB signaling and NB signaling, according to some embodiments. For example, the wireless device 105 may have both an NB radio and a UWB radio. The wireless device may have a Hybrid Wireless Transceiver (HWT) 240 comprising an NB Subsystem 250 and a UWB Subsystem 260 that are tightly coupled with each other. The NB Subsystem 250 may communicate directly with the NB Subsystem of another similarly configured wireless device, and the UWB Subsystem 260 may communicate directly with the UWB Subsystem of another similarly configured wireless device. In FIG. 2, the NB Subsystem 250 is shown to have its own physical antenna 270 and the UWB Subsystem 260 has its own physical antenna 280, but a single shared antenna covering both NB and UWB operations may also be a suitable implementation. A multi-antenna solution may be utilized for such advanced signal processing schemes as antenna diversity, spatial multiplexing, or transmit or receive beamforming. The HWT 240, NB Subsystem 250, or the UWB Subsystem 260 may be components that are separate from the transceiver 225 or may also be components of the transceiver 225.

As previously mentioned, narrowband-aided multi-millisecond (NBA-MMS) has been proposed as a ranging technique. A narrowband (NB) radio can assist an Ultra-wideband (UWB) radio with ranging, e.g., by improving the UWB radio's link budget and/or extending its operational range. Ranging may be either Peer-to-Peer (P2P) involving two devices, or Multi-Peer (MP) involving multiple devices. Prior to ranging, devices can time synchronize with each other, e.g., by performing NB acquisition. In a typical process, an Initiator (also referred to as a Finder) broadcasts one or more NB Acquisition Poll (NAPs) packets. A Responder (also referred to as a Findee) scans for NAPs and, upon reception of one or more NAPs, transmits an NB Acquisition Response (NAR) packet. Acquisition is completed when the Initiator sends a final Start of Ranging (SOR) packet.

The example embodiments provide improved techniques for ranging using NBA-MMS and for performing NB acquisition. In some example embodiments, out of band (OOB) methods to trigger NB acquisition are proposed. Cellular device finding applications, such as Apple's FindMy app, may use NBA-MMS ranging to find a device for which the location has been shared. In a proposed NB acquisition process according to some example embodiments, to start the NB acquisition process, a Finder (such as the primary device 105 in FIG. 1) triggers a Findee (such as any of secondary devices 110-130, FIG. 1) to start NB advertising. The Findee in turn triggers the Finder to start NB scanning. The proposed NB acquisition process involves utilizing two logically-equivalent parallel methods of triggering the remote device in both directions (Finder-Findee & Findee-Finder). In some example embodiments, this may be done via the internet, where connectivity is available. In other example embodiments, the two logically equivalent parallel methods of triggering the remote device in both directions may be done peer-to-peer, e.g., via a Bluetooth Low energy (BLE) advertisement where internet connectivity is not available. Notably, both methods are executed in parallel and the remote device may be triggered when one of the methods succeeds.

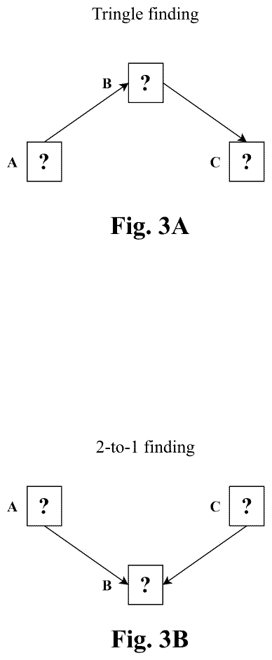

In other example embodiments, multi-peer finding scenarios and techniques are proposed. A typical Peer-to-Peer ranging scenario involves one Finder (or initiator) and one Findee (or responder). However, it may be desirable to handle multi-peer ranging in a multi-device manner, such as: Device A finding Device B; Device B finding Device C; and Devices A and C each finding Device B. FIGS. 3A and 3B illustrate these example scenarios. FIG. 3A shows an example of a triangle finding scenario between multiple wireless devices according to various example embodiments. In triangle finding, Device A is trying to find Device B, and Device B is trying to find Device C. FIG. 3B shows an example of a two device-to-one-device finding scenario between multiple wireless devices according to various example embodiments. In FIG. 3B, both devices A and C are trying to find Device B. In the situations shown in FIGS. 3A and 3B, each device can run multiple concurrent NBA-MMS ranging sessions, which can start asynchronously. For example, A-B ranging may have already started when B wants to start ranging with C.

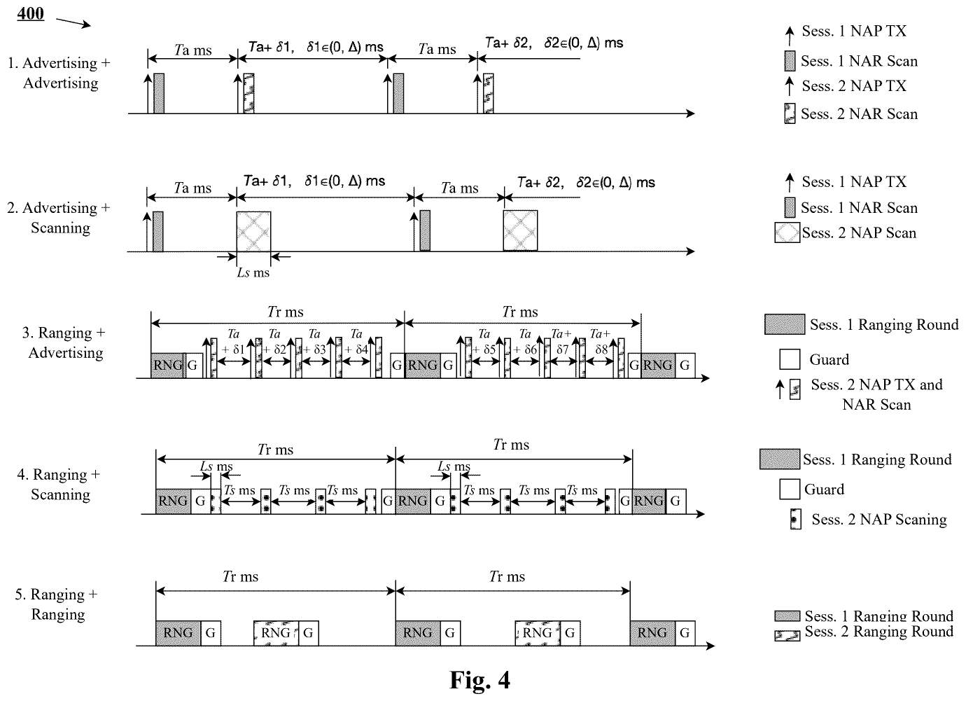

In order to accomplish the two concurrent NBA-MMS ranging sessions starting asynchronously, the device may perform multi-peer scheduling for multi-peer finding. FIG. 4 shows an example multi-peer scheduling technique for multi-peer finding according to various embodiments.

FIG. 4 is from the perspective of one of the devices, e.g., Device B in FIGS. 3A-3B, which may be associated with Devices A and C. As mentioned, prior to ranging, devices time synchronize by performing NB acquisition. This may be done by performing one or more advertising and/or scanning operations. An initiator device may advertise or broadcast, such as by broadcasting NB Acquisition Poll (NAPs) packets. A responder may perform scanning for one or more other devices, such as scanning for NAPs and, upon reception, may transmit an NB Acquisition Response (NAR) packet. Acquisition may be completed when the Initiator sends a final Start of Ranging (SOR) packet.

In the scheduling technique 400 of FIG. 4, for multi-peer finding, each device, such as Device B, may be both an Initiator and a Responder. Thus, Device B may start NB advertising to let other devices know it is available. Device B may also, at some point, start NB scanning to determine what other devices are available. In the 2-to-1 finding scenario depicted in FIG. 3B, as seen in Line 1 of FIG. 4, Device B may be advertising for multiple devices. In FIG. 4, advertising for only two devices is shown, but advertising may be performed for more than two devices. As seen in Line 1 of FIG. 4, advertisements for two devices may be interleaved. In an advertising interval Ta, Device B may advertise for a first session (e.g., with Device A) by broadcasting a first NAP (Sess 1 NAP TX) and scanning for an associated NAR (Sess 1 NAR Scan). In a second advertising interval, Device B may advertise for a second session (e.g., with Device C) by broadcasting a second NAP (Sess 2 NAP TX) and scanning for an associated NAR (Sess 2 NAR Scan). Device B may then repeat the advertising for the first session and may alternate between advertising for the first and second sessions. The advertising intervals may be fixed or may be dithered by adding a wait or delay (delay ∂), where ∂ is chosen randomly from (0, Δ). For example, in FIG. 4, the advertising interval for the first iteration of advertising for the second session may be Ta+∂1, and the advertising interval for the second iteration of advertising for the second session may be Ta+∂2.

In the triangle finding scenario depicted in FIG. 3A, Device B may start scanning for other devices. For example, Device B may start scanning for Device C, as seen in Line 2 of FIG. 4. Device B may still be advertising for Device A. So, as seen in Line 2, Device B may interleave or alternate advertising for Device A with scanning for Device C. Thus, in a first advertising interval, Device B advertises for a first session (e.g., with Device A) by broadcasting a first NAP (Sess 1 NAP TX) and scanning for an associated NAR (Sess 1 NAR Scan). Then, in a second advertising interval, Device B may scan for the second session with Device C (session 2 NAP scan). Each scan may last a fixed period of Ls ms, although in other example embodiments, the length of the scans may vary. The advertising and scanning may be repeated by continuing to interleave, or alternate, the advertising and scanning in successive timing intervals. The timing intervals may be fixed or may be dithered by adding a wait or delay (delay ∂), where ∂ is chosen randomly from (0, Δ). For example, in FIG. 4, the timing interval for the scanning for the second session may be Ta+∂1, and the timing interval for the second iteration of scanning for the second session may be Ta+∂2. Note that although the above description is for advertising for a first session with a first device and scanning for a second session with a second device, this is only an example. It could be the other way around—advertising for a second session with a second device and scanning for a first session with a first device. In any event, advertising and scanning may be alternated by the same device in successive timing intervals.

Now, assume that Device B has achieved NB acquisition with Device A but is still advertising for Device B. At this point, Device B is ready for ranging with Device A. Ranging and advertising may also be interleaved or alternated by the device (e.g., Device B), as seen in Line of FIG. 4. In Line 3, in a ranging interval Tr, Device B may perform ranging with a first responder device (e.g., Device A) (Sess 1 ranging round RNG). In the same ranging interval Tr, Device B may also continue to advertise for Device C by broadcasting a second NAP (Sess 2 NAP TX) and scanning for an associated NAR (Sess 2 NAR Scan). A guard or gap G may be interposed between the ranging and the advertising. Multiple advertising broadcasts may be performed in the ranging interval Tr. Although FIG. 4 shows five broadcasts, this is only an example, and the number of broadcasts may vary. In various example embodiments, the broadcasts may be sent using a dither such that successive broadcasts may be separated by a time period of Ta+∂1, Ta+∂2, Ta+∂3, Ta+∂4, etc., as seen in FIG. 4. In successive ranging intervals, the ranging and advertising may continue to be included in each ranging interval Tr. The ranging interval may be fixed or a dither (wait or delay ∂) may be added.

A device, such as Device B, may also perform ranging with one device (e.g. Device A) while scanning for another device (e.g., Device C), as seen in Line 4 of FIG. 4. In this situation, ranging and scanning may also be interleaved or alternated by the device (e.g., Device B), as seen in Line 4 of FIG. 4. In Line 4, in a ranging interval Tr, Device B may perform ranging with a first responder device (e.g., Device A) (Sess 1 ranging round RNG). In the same ranging interval Tr, Device B may also scan for Device C (Sess 2 NAP Scanning). A guard or gap G may be interposed between the ranging and the scanning. Multiple scans may be performed in the ranging interval Tr. Although FIG. 4 shows four scans, this is an example only, and the number of scans may vary. In various example embodiments, the scans may occur periodically every Ts milliseconds (ms), where Ts is a fixed value. In other example embodiments, Ts may vary. Each scan may last a fixed period of Ls ms, although in other example embodiments, the length of the scans may vary. In successive ranging intervals, the ranging and scanning may continue to be included in each ranging interval Tr. Another guard or gap G may be included at an end of the ranging interval to separate the scans from the next Ranging Round. The ranging interval may be fixed or may include a dither (wait or delay ∂).

Finally, an initiator device (such as Device B) may be involved in ranging with multiple devices (such as Devices A and C), as seen in Line 5 of FIG. 4. In this situation, ranging with a first device and ranging with a second device may be interleaved or alternated by the device (e.g., Device B), as seen in Line 5 of FIG. 4. In Line 5, in a ranging interval Tr, Device B may perform ranging with a first responder device (e.g., Device A) (Sess 1 ranging round RNG). In the same ranging interval Tr, the device (Device B) may perform ranging with a second responder device (e.g., Device C) (Sess 2 ranging round RNG). A guard or gap G may be inserted at the end of each ranging round. Although FIG. 4 shows only two ranging rounds in each ranging interval (one with each device), this is an example only, and multiple ranging rounds may be included in each ranging interval Tr. In one embodiment, the ranging interval Tr may be two hundred (200) ms at ten (10) Hertz. In some example embodiments, the ranging interval Tr may be split into two intervals (e.g. 100 ms each) at five (5) Hz each. In other example embodiments, the ranging interval Tr may be made longer to include more ranging rounds in each ranging interval. In successive ranging intervals, the ranging rounds for each session with the different devices may continue to be included in each ranging interval Tr. The ranging interval may be fixed or may include a dither (wait or delay ∂).

The advertising interval Ta and the ranging interval Tr may be referred to generally as timing intervals.

In other example embodiments, additional improved techniques for ranging using NBA-MMS may be used. For example, improved techniques for NBA-MMS ranging in congested settings are proposed.

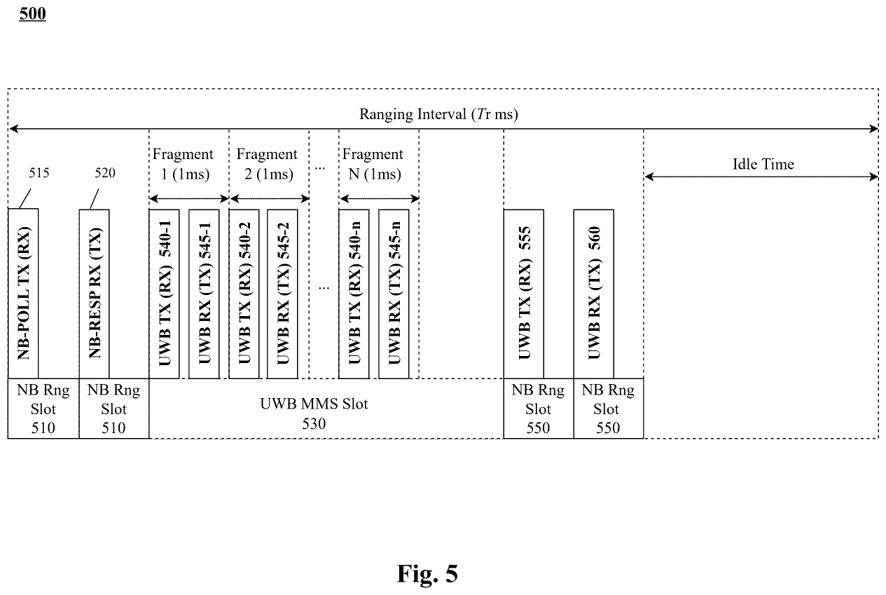

In certain situations, there may be many device pairs ranging near each other, which may cause interference between devices that are trying to find one another. A device, through its upper layer software, may recognize the congestion and implement improved techniques for NBA-MMS ranging. FIG. 5 shows an example NBA-MMS protocol for one ranging cycle according to various example embodiments. Each ranging cycle or interval, such as ranging cycle 500 in FIG. 5, may include NB ranging slots 510. In one embodiment, the NB ranging slots 510 may be for a NB Poll TX 515 and a NB Response RX 520. The ranging cycle may also include a UWB MMS slot 530 which may comprise UWB TX fragments 540-1 to 540-n and RX fragments 545-1 to 545-n. In some example embodiments, each UWB TX fragment 540 and RX fragment 545 is one ms. The ranging cycle may also include NB data slots 550 which may include NB DATA TX 555 and NB DATA RX 560. If multiple devices in the same area are on the same cadence, i.e., they have the same or similar ranging intervals, there may be significant interference between the devices.

To address the NBA-MMS ranging in a congested setting, in some example embodiments, a UWB preamble on each ranging cycle may be randomly selected from a set of N preamble sequences, where N is a positive integer. In other example embodiments, a ranging interval may be delayed by adding an amount of delay ∂ to Tr, where ∂ is chosen randomly from (0, Δ) on each ranging cycle. In one embodiment, these two approaches may be combined such that both the UWB preamble on each ranging cycle is randomly selected from a set of N preamble sequences, and the ranging interval may be dithered by adding a random delay ∂ to Tr, where a is chosen randomly from (0, Δ) on each ranging cycle.

The example embodiments disclosed herein provide improved techniques for concurrent ranging for wireless devices using NBA-MMS and for performing NB acquisition. In particular, multi-peer finding scenarios and techniques are disclosed, allowing for effective multi-peer scheduling for multi-peer finding such that a wireless device may concurrently find, and perform ranging with, multiple other wireless devices at the same time. In addition, the techniques disclosed herein provide for more effective NBA-MMS ranging in congested settings.

### Examples

In a first example, a method, comprising performing one or more of an advertising operation, a scanning operation, and a Narrowband-aided multi-millisecond (NBA-MMS) ranging operation for a first wireless device in a first timing interval and performing one or more of an advertising operation, a scanning operation, and an NBA-MMS ranging operation for a second wireless device in the first timing interval or a successive timing interval.

In a second example, the method of the first example, wherein the first timing interval is a first advertising interval, and the method further comprises performing a first advertising operation for the first wireless device in the first advertising interval and performing a first advertising operation for the second wireless device in a second advertising interval successive to the first advertising interval.

In a third example, the method of the second example, wherein the first advertising operation for the first wireless device comprises broadcasting one or more first Narrowband Acquisition Poll (NAP) packets and scanning for associated Narrowband Acquisition Response (NAR) packets from the first wireless device, and the first advertising operation for the second wireless device comprises broadcasting one or more second NAP packets and scanning for associated NAR packets from the second wireless device.

In a fourth example, the method of the second example, wherein the method alternates between performing advertising operations for the first wireless device and performing advertising operations for the second wireless device in alternating successive advertising intervals.

In a fifth example, the method of the second example, wherein one or both of the first advertising interval and the second advertising interval is of a fixed duration.

In a sixth example, the method of the second example, wherein one or both of the first advertising interval and the second advertising interval includes a randomly chosen dither delay period.

In a seventh example, the method of the first example, wherein the first timing interval is a first advertising interval, wherein the method further comprises performing a first advertising operation for the first wireless device in the first advertising interval and performing a first scanning operation for the second wireless device in the second timing interval which is successive to the first advertising interval.

In an eighth example, the method of the seventh example, wherein the second timing interval has a duration that is a duration of the first advertising interval plus a randomly chosen dither delay period.

In a ninth example, the method of the seventh example, wherein the first advertising operation for the first wireless device comprises broadcasting one or more first Narrowband Acquisition Poll (NAP) packets and scanning for associated Narrowband Acquisition Response (NAR) packets, and the first scanning operation for the second wireless device comprises scanning for NAP packets from the second wireless device.

In a tenth example, the method of the seventh example, wherein the method alternates between performing advertising operations for the first wireless device and performing scanning operations for the second wireless device in alternating successive timing intervals.

In an eleventh example, the method of the first example, wherein the first timing interval is a first ranging interval, wherein the method further comprises performing a first NBA-MMS ranging operation for the first wireless device in the first ranging interval and performing a first advertising operation for the second wireless device in the first ranging interval.

In a twelfth example, the method of the eleventh example, wherein the first advertising operation for the second wireless device comprises broadcasting one or more second Narrowband Acquisition Poll (NAP) packets and scanning for associated NAR packets from the second wireless device.

In a thirteenth example, the method of the eleventh example, wherein the first advertising operation for the second wireless device comprises multiple broadcasts in the first ranging interval.

In a fourteenth example, the method of the thirteenth example, wherein the multiple broadcasts are each separated by a randomly chosen dither delay period.

In a fifteenth example, the method of the eleventh example, wherein the method comprises performing a second NBA-MMS ranging operation for the first wireless device and perform a second advertising operation for the second wireless device in a second ranging interval that is successive to the first ranging interval, wherein the second advertising operation for the second wireless device comprises multiple broadcasts of one or more second Narrowband Acquisition Poll (NAP) packets and multiple scans for associated NAR packets from the second wireless device in the second ranging interval.

In a sixteenth example, the method of the fifteenth example, wherein one or both of the first ranging interval and the second ranging interval includes a randomly chosen dither delay period.

In a seventeenth example, the method of the first example, wherein the first timing interval is a first ranging interval, and the method further comprises performing a first NBA-MMS ranging operation for the first wireless device in the first ranging interval and performing a first scanning operation for the second wireless device in the first ranging interval.

In an eighteenth example, the method of the seventeenth example, wherein the first scanning operation for the second wireless device comprises scanning for Narrowband Acquisition Poll (NAP) packets from the second wireless device

In a nineteenth example, the method of the seventeenth example, wherein the first scanning operation for the second wireless device comprises multiple scans in the first ranging interval.

In a twentieth example, the method of the nineteenth example, wherein the multiple scans occur periodically.

In a twenty first example, the method of the seventeenth example, wherein the method comprises performing a second NBA-MMS ranging operation for the first wireless device and perform a second scanning operation for the second wireless device in a second ranging interval that is successive to the first ranging interval, wherein the second scanning operation for the second wireless device comprises multiple scans for Narrowband Acquisition Poll (NAP) packets from the second wireless device in the second ranging interval.

In a twenty second example, the method of the first example, wherein the first timing interval is a first ranging interval, and the method further comprises performing a first NBA-MMS ranging operation for the first wireless device in the first ranging interval and performing a first NBA-MMS ranging operation for the second wireless device in the first ranging interval.

In a twenty third example, the method of the twenty second example, wherein one or both of the first NBA-MMS ranging operation for the first wireless device and the first scanning operation for the second wireless device comprises multiple ranging rounds.

In a twenty fourth example, the method of the twenty second example, wherein the method comprises performing a second NBA-MMS ranging operation for the first wireless device and to perform a second NBA-MMS ranging operation for the second wireless device in a second ranging interval that is successive to the first ranging interval.

In a twenty fifth example, the method of the twenty fourth example, wherein one or both of the first ranging interval and the second ranging interval includes a randomly chosen dither delay period.

In a twenty sixth example, the method of the twenty second example, wherein the method comprises randomly selecting an ultra-wideband (UWB) preamble for the first ranging interval, the UWB preamble being randomly selected from a set of N preamble sequences, wherein N is a positive integer.

In a twenty seventh example, the method of the twenty fourth example, wherein the method comprises adding a dither delay period to each of the first and second ranging intervals, where the amount of the dither delay period is randomly selected for each of the first and second ranging intervals.

In a twenty eighth example, the method of the twenty fourth example, further comprising randomly selecting an ultra-wideband (UWB) preamble for the first ranging interval, the UWB preamble being randomly selected from a set of N preamble sequences, wherein N is a positive integer and adding a dither delay period to each of the first and second ranging intervals, where the amount of the dither delay period is randomly selected for each of the first and second ranging intervals.

In a twenty ninth example, a processor configured to perform any of the methods of the first through twenty eight examples.

In a thirtieth example, a wireless device configured to perform any of the methods of the first through twenty eight examples.

In a thirty first example, a method, comprising performing a first Narrowband-aided multi-millisecond (NBA-MMS) ranging operation for a first wireless device in a first ranging interval, performing a second NBA-MMS ranging operation for the first wireless device in a second ranging interval successive to the first ranging interval, and performing at least one of the following, randomly selecting an ultra-wideband (UWB) preamble for one or more of the first ranging interval and the second ranging interval, the UWB preamble being randomly selected from a set of N preamble sequences, wherein N is a positive integer or adding a dither delay period to each of the first and second ranging intervals, where the amount of the dither delay period is randomly selected for each of the first and second ranging intervals.

In a thirty second example, the method of the thirty first example, wherein the method performs both of randomly selecting the ultra-wideband (UWB) preamble for each of the first ranging interval and the second ranging interval and adding the dither delay period to each of the first and second ranging intervals, where the amount of the dither delay period is randomly selected for each of the first and second ranging intervals.

In a thirty third example, a processor configured to perform any of the methods of the thirty first through thirty second examples.

In a thirty fourth example, a wireless device configured to perform any of the methods of the thirty first through thirty second examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. In a further example, the example embodiments of the above-described method may be embodied as a program containing lines of code stored on a non-transitory computer readable storage medium that, when compiled, may be executed on a processor or microprocessor.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE or other wireless device) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICs. In other embodiments, the present invention may be realized using one or more programmable hardware elements such as FPGAs.

Although this application described various aspects each having different features in various combinations, those skilled in the art will understand that any of the features of one aspect may be combined with the features of the other aspects in any manner not specifically disclaimed or which is not functionally or logically inconsistent with the operation of the device or the stated functions of the disclosed aspects.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalents.

What is claimed:

1. An apparatus comprising processing circuitry coupled to memory, the processing circuitry configured to:
perform one or more of an advertising operation, a scanning operation, and a Narrowband-aided multi-millisecond (NBA-MMS) ranging operation for a first wireless device in a first timing interval; and
perform one or more of an advertising operation, a scanning operation, and an NBA-MMS ranging operation for a second wireless device in the first timing interval or a successive timing interval.

2. The apparatus of claim 1, wherein the first timing interval is a first advertising interval, and the processing circuitry is configured to:
perform a first advertising operation for the first wireless device in the first advertising interval; and
perform a first advertising operation for the second wireless device in a second advertising interval successive to the first advertising interval.

3. The apparatus of claim 2, wherein the first advertising operation for the first wireless device comprises broadcasting one or more first Narrowband Acquisition Poll (NAP) packets and scanning for associated Narrowband Acquisition Response (NAR) packets from the first wireless device, and the first advertising operation for the second wireless device comprises broadcasting one or more second NAP packets and scanning for associated NAR packets from the second wireless device.

4. The apparatus of claim 2, wherein the processing circuitry is configured to alternate between performing advertising operations for the first wireless device and performing advertising operations for the second wireless device in alternating successive advertising intervals.

5. The apparatus of claim 2, wherein one or both of the first advertising interval and the second advertising interval is of a fixed duration.

6. The apparatus of claim 2, wherein one or both of the first advertising interval and the second advertising interval includes a randomly chosen dither delay period.

7. The apparatus of claim 1, wherein the first timing interval is a first advertising interval, and the processing circuitry is configured to:
perform a first advertising operation for the first wireless device in the first advertising interval; and
perform a first scanning operation for the second wireless device in the second timing interval which is successive to the first advertising interval.

8. The apparatus of claim 7, wherein the second timing interval has a duration that is a duration of the first advertising interval plus a randomly chosen dither delay period.

9. The apparatus of claim 7, wherein the first advertising operation for the first wireless device comprises broadcasting one or more first Narrowband Acquisition Poll (NAP) packets and scanning for associated Narrowband Acquisition Response (NAR) packets, and the first scanning operation for the second wireless device comprises scanning for NAP packets from the second wireless device.

10. The apparatus of claim 7, wherein the processing circuitry is configured to alternate between performing advertising operations for the first wireless device and performing scanning operations for the second wireless device in alternating successive timing intervals.

11. The apparatus of claim 1, wherein the first timing interval is a first ranging interval, and the processing circuitry is configured to:
perform a first NBA-MMS ranging operation for the first wireless device in the first ranging interval; and
perform a first advertising operation for the second wireless device in the first ranging interval.

12. The apparatus of claim 11, wherein the first advertising operation for the second wireless device comprises broadcasting one or more second Narrowband Acquisition Poll (NAP) packets and scanning for associated NAR packets from the second wireless device.

13. The apparatus of claim 11, wherein the first advertising operation for the second wireless device comprises multiple broadcasts in the first ranging interval.

14. The apparatus of claim 13, wherein the multiple broadcasts are each separated by a randomly chosen dither delay period.

15. The apparatus of claim 11, wherein the processing circuitry is configured to perform a second NBA-MMS ranging operation for the first wireless device and perform a second advertising operation for the second wireless device in a second ranging interval that is successive to the first ranging interval, wherein the second advertising operation for the second wireless device comprises multiple broadcasts of one or more second Narrowband Acquisition Poll (NAP) packets and multiple scans for associated NAR packets from the second wireless device in the second ranging interval.

16. The apparatus of claim 15, wherein one or both of the first ranging interval and the second ranging interval includes a randomly chosen dither delay period.

17. The apparatus of claim 1, wherein the first timing interval is a first ranging interval, and the processing circuitry is configured to:
perform a first NBA-MMS ranging operation for the first wireless device in the first ranging interval; and
perform a first scanning operation for the second wireless device in the first ranging interval.

18. The apparatus of claim 17, wherein the first scanning operation for the second wireless device comprises scanning for Narrowband Acquisition Poll (NAP) packets from the second wireless device.

19. An apparatus comprising processing circuitry coupled to memory, the processing circuitry configured to:
perform a first Narrowband-aided multi-millisecond (NBA-MMS) ranging operation for a first wireless device in a first ranging interval;
perform a second NBA-MMS ranging operation for the first wireless device in a second ranging interval successive to the first ranging interval; and
perform at least one of the following:
randomly select an ultra-wideband (UWB) preamble for one or more of the first ranging interval and the second ranging interval, the UWB preamble being randomly selected from a set of N preamble sequences, wherein N is a positive integer; or
add a dither delay period to each of the first and second ranging intervals, where the amount of the dither delay period is randomly selected for each of the first and second ranging intervals.

20. The apparatus of claim 19, wherein the processing circuitry is configured to perform both of:
randomly selecting the ultra-wideband (UWB) preamble for each of the first ranging interval and the second ranging interval; and
adding the dither delay period to each of the first and second ranging intervals, where the amount of the dither delay period is randomly selected for each of the first and second ranging intervals.
